(19) United States
(12) Patent Application Publication
(10) Pub. No.: US 2026/0307970 A1
(43) Pub. Date: Oct. 8, 2026

(54) MACHINE FOR SEALING CONTAINERS BY CONCENTRIC COMPRESSION OF THE STOPPER

(71) Applicant: PEP TECHNOLOGIES, LE CHEYLARD (FR)

(72) Inventor: Philippe PERRIER, LE CHEYLARD (FR)

(73) Assignee: PEP TECHNOLOGIES, LE CHEYLARD (FR)

(21) Appl. No.: 19/484,752

(22) PCT Filed: May 17, 2024
(86) PCT No.: PCT/FR2024/050639

§ 371 Date: Nov. 14, 2025

(30) Foreign Application Priority Data
May 17, 2023 (FR) FR2304946

(51) Int. Cl. B67B 1/04

(52) U.S. Cl. CPC B67B 1/04

(57) ABSTRACT

The invention relates to a machine for sealing containers, including: a device for radially compressing stoppers, comprising movable jaws defining a receiving opening for receiving a stopper, and a system for displacing the movable jaws in reciprocating movements in order to modify the arrangement thereof during the movements, between an open configuration, in which the receiving opening can receive a stopper, and a closed configuration, in which the receiving opening compresses the stopper, all the movable jaws being mounted so as to be able to move in convergent directions, and wherein the system for displacing the movable jaws ensures the concentric displacement of all the movable jaws in order to ensure concentric compression of the stopper; and a device for inserting a stopper into the neck of a container, the movement of which is independent of the movement of the displacement system of the movable jaws.

### CROSS REFERENCE TO RELATED APPLICATIONS

This application is a 35 U.S.C. § 371 National Stage of International Patent Application No. PCT/FR2024/050639, filed May 17, 2024, which claims priority to French Application No. FR2304946, filed May 17, 2023.

### TECHNICAL FIELD

The present invention concerns a sealing machine, in particular a machine capable of inserting stoppers, in particular made of natural or synthetic cork or of plastic or similar material, into the neck of containers and in particular bottles.

The subject matter of the invention has particularly advantageous applications for sealing bottles filled with still and/or sparkling wines.

### BACKGROUND

The prior art includes numerous machines for sealing containers by inserting stoppers into the necks of the containers. For example, patent EP 1314683 describes a machine comprising a frame arranged in the form of a carousel delimiting a plurality of sealing stations. Each sealing station comprises a support surface for a container and a vice-type of radial stopper compression device with movable jaws defining a receiving opening for a stopper. The jaws are displaced in reciprocating movements by a displacement system with cams, in order to modify their arrangement during the movements, between an open configuration, in which the receiving opening can receive a stopper, and a closed configuration, in which the receiving opening compresses the stopper.

This machine also comprises devices for inserting a stopper inside the neck of a container, comprising a push rod, driven by a reciprocating movement in such a way that the push rod reaches an insertion position in which the stopper is completely inserted inside the neck of the container.

The prior art has proposed various solutions for making vice-type radial compression devices for stoppers. For example, patent EP 1 426 322 describes a radial compression device comprising a fixed slide provided with a pair of compression blocks, and a movable slide provided with a pair of compression blocks, and actuated by a reciprocating movement relative to the fixed slide. In this case, the stopper is compressed by the clamping action of four perpendicular jaws that slide against each other. Two of the four jaws are on a slide forming a movable jaw assembly and the other two opposite jaws are on another fixed slide. The movable jaw assembly is displaced towards the fixed jaw assembly via a cam, enabling the final compression of the stopper to be achieved. The stopper compresses as it is displaced from the movable jaw assembly to the fixed jaw assembly. This movement transcribes a translation generating an eccentric compression with respect to the central axis of the bottle neck.

In practice, the sealing achieved by such a machine is not entirely satisfactory. Indeed, a certain number of containers have been observed to have a curl inside the stopper, resulting in a poor quality sealing, reducing the lifespan of the seal and increasing the risk of leakage through the curl. The presence of particles or dust arising from the stopper that could clog the jaws or even find their way into the neck of the container has also been determined. Furthermore, it has been observed that the quality of the sealing was not uniform, in particular when the rate of sealing varied. It has also been shown that such a compression device is not suitable for receiving stoppers of different diameters. More specifically, the sealing machines are configured to operate with a single stopper diameter. A larger diameter stopper is more compressed than a smaller diameter stopper, leading to deterioration of the cork cells which affect the mechanical properties of the stopper, in particular its elasticity in regaining diameter in the neck of the container after compression. This has a significant impact on the sealing and lifespan of the stopper. Moreover, the eccentric compression of a wider stopper does not allow for perfect centring of the entry of the stopper into the neck of the container, as it is pushed in eccentrically manner due to its eccentric compression. This causes the inside of the stopper to curl, resulting in a poor-quality sealing.

### SUMMARY OF THE INVENTION

The present invention aims to overcome the disadvantages of the prior art by proposing a novel machine for improving container sealing while preserving the stopper and offering flexibility in the face of different container and stopper formats.

To achieve such an objective, the machine according to the invention comprises a frame delimiting at least one sealing station, each having:
a support surface for a container;
a radial stopper compression device comprising movable jaws defining a receiving opening for a stopper and a system for reciprocating displacement of the movable jaws, in order to modify their arrangement during the movements, between an open configuration, in which the receiving opening can receive a stopper, and a closed configuration, in which the receiving opening compresses the stopper:
a device for inserting a stopper into the neck of a container, comprising a push rod driven in a reciprocating movement in such a way that the push rod reaches an insertion position in which the stopper is completely inserted into the neck of the container. In accordance with the invention:
all the movable jaws of the compression device are mounted so as to be movable in directions converging at a point;
the displacement system of the movable jaws ensures the concentric displacement of all the movable jaws, in order to ensure concentric compression of the stopper;
the insertion device comprises an actuation system of the push rod, the movement of which is independent of the movement of the displacement system of the movable jaws.

According to an advantageous design feature, the displacement system of the jaws comprises at least one first actuator driven by a control unit to displace all the movable jaws concentrically in order to ensure concentric compression of the stopper, while the system for actuating the push rod comprises a second actuator driven by the control unit to insert the compressed stopper inside the neck of the container.

Advantageously, the second actuator is driven to disengage the push rod from the receiving opening after insertion of the stopper into the neck, while the first actuator is driven by the control unit to displace the movable jaws so as to be arranged in their open configuration in order to be able to receive a new stopper.

Preferably, the first actuator has an adjustable actuating speed making it possible to adjust the speed of displacement of the jaws in order to adjust the speed of compression of the stopper, while the second actuator has an adjustable actuating speed making it possible to adjust the speed of the push rod so as to adjust the speed of insertion of the stopper independently of the speed of compression of the stopper.

According to a preferred embodiment, the compression device comprises a first slide which can move in translation acting on two movable jaws, and a second slide which can move in translation acting on two other movable jaws, the first slide and the second slide being guided in translation in the same direction and being displaced in opposite senses.

Preferably, the first slide and the second slide are displaced by means of a control part provided with a cam system and actuated in alternating sliding by a first actuator.

In an advantageous embodiment, the first slide and/or the second slide are provided with an adjustment system for centring the movable jaws.

In one embodiment, the compression device comprises an annular control part controlled in alternating rotation by a first actuator and acting simultaneously on all the movable jaws, in order to modify their arrangement during movements, between the open configuration and the closed configuration.

Typically, the compression device comprises between three and twelve movable jaws and the annular control part acts on the movable jaws distributed angularly inside the annular control part.

### BRIEF DESCRIPTION OF THE DRAWINGS

FIG. 1 is a perspective view showing an example of a sealing machine in accordance with the invention.

FIG. 2 is a larger-scale perspective view of the sealing machine illustrated in FIG. 1.

FIG. 3 is a view of an embodiment of the compression device of the sealing machine, illustrated in the open configuration.

FIG. 4 is a view of an embodiment of the compression device of the sealing machine, illustrated in the closed configuration.

FIGS. 5A to 5C are views of the concentric compression device in accordance with the invention, illustrated respectively in minimum compression (A), intermediate compression (B) and maximum compression (C).

FIGS. 6A to 6C are views of an eccentric compression device in accordance with the prior art, illustrated respectively in minimum compression (A), intermediate compression (B) and maximum compression (C).

FIGS. 7A and 7B are schematic top views showing a stopper before its return to elasticity, mounted inside the neck of a container, with respectively a strong compression (A) and a weak compression (B) carried out by a concentric compression device in accordance with the invention, while FIGS. 7C and 7D are schematic profile views showing a stopper before its return to elasticity, mounted inside the neck of a container, with respectively a strong compression (C) and a weak compression (D) carried out by a concentric compression device in accordance with the invention.

FIGS. 8A and 8B are schematic top views showing a stopper before its return to elasticity, mounted inside the neck of a container, with respectively a strong compression (A) and a weak compression (B) carried out by an eccentric compression device in accordance with the prior art, while FIGS. 8C and 8D are schematic profile views showing a stopper before its return to elasticity, mounted inside the neck of a container, with respectively a strong compression (C) and a weak compression (D) carried out by an eccentric compression device in accordance with the prior art.

FIGS. 9A and 9B are schematic top views showing the positioning of the push rod for a stopper before its return to elasticity, mounted inside the neck of a container, with respectively a strong compression (A) and a weak compression (B) carried out by an eccentric compression device in accordance with the prior art, while FIGS. 9C and 9D are schematic profile views showing the positioning of the push rod for a stopper before its return to elasticity, mounted inside the neck of a container, with respectively a strong compression (C) and a weak compression (D) carried out by an eccentric compression device in accordance with the prior art.

FIGS. 10A and 10B are schematic top views showing the positioning of the push rod for a stopper before its return to elasticity, mounted inside the neck of a container, with respectively a strong compression (A) and a weak compression (B) carried out by a concentric compression device in accordance with the invention, while FIGS. 10C and 10D are schematic profile views showing the positioning of the push rod for a stopper before its return to elasticity, mounted inside the neck of a container, with respectively a strong compression (C) and a weak compression (D) carried out by a concentric compression device in accordance with the invention.

FIG. 11 is a view of an example of a stopper with a curl.

FIG. 12 is a view of another embodiment of the compression device in accordance with the invention, comprising eight movable jaws.

### DETAILED DESCRIPTION

As can be seen from the drawings, the subject matter of the invention relates to a machine 1 for sealing containers provided with a neck 2, such as bottles, by inserting stoppers 3 inside the necks 2 of the containers. The machine 1 comprises a frame 4 delimiting at least one sealing station and, in the illustrated example, only one sealing station 5. Of course, the sealing machine 1 can be configured to include a plurality of sealing stations 5 distributed linearly or angularly, in the form of a carousel, for example.

Each sealing station 5 comprises a support surface 6 for a container and, more specifically, for the bottom of the container. Typically, the containers are fed successively onto the support surface 6 and removed successively after they have been sealed, using all types of handling systems such as transfer starwheels, for example.

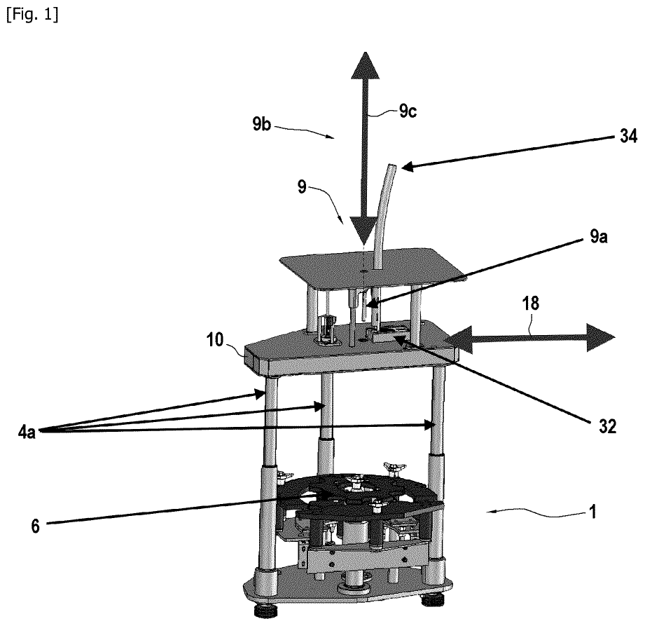

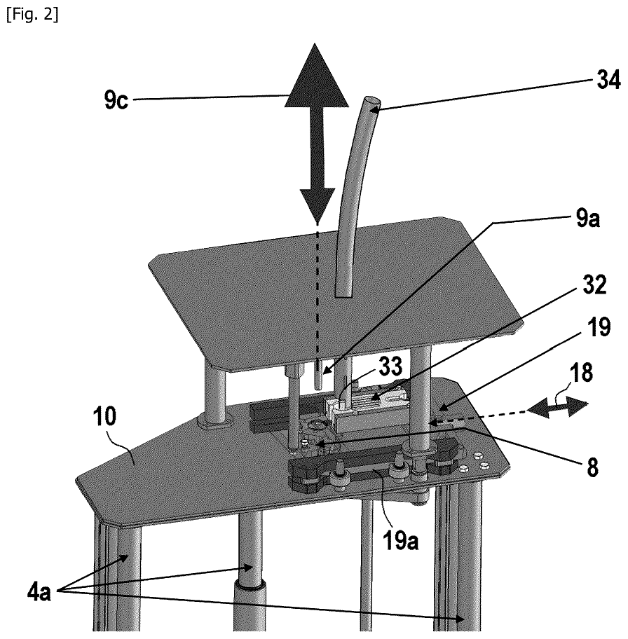

Each sealing station 5 comprises a radial compression device 8 for the stoppers 3 and an insertion device 9 suitable for engaging the newly compressed cork inside the neck 2 of a container. As shown in FIGS. 1 and 2, the radial compression device 8 is mounted on a table 10 presented by the frame 4, while the insertion device 9 is positioned above the radial compression device 8. Advantageously, the table 10 can be moved vertically so that the distance between the container support surface 6 and the radial compression device 8 can be adjusted as a function of the size of the containers. For example, the table 10 is supported by three telescopic posts 4a forming part of the frame 4.

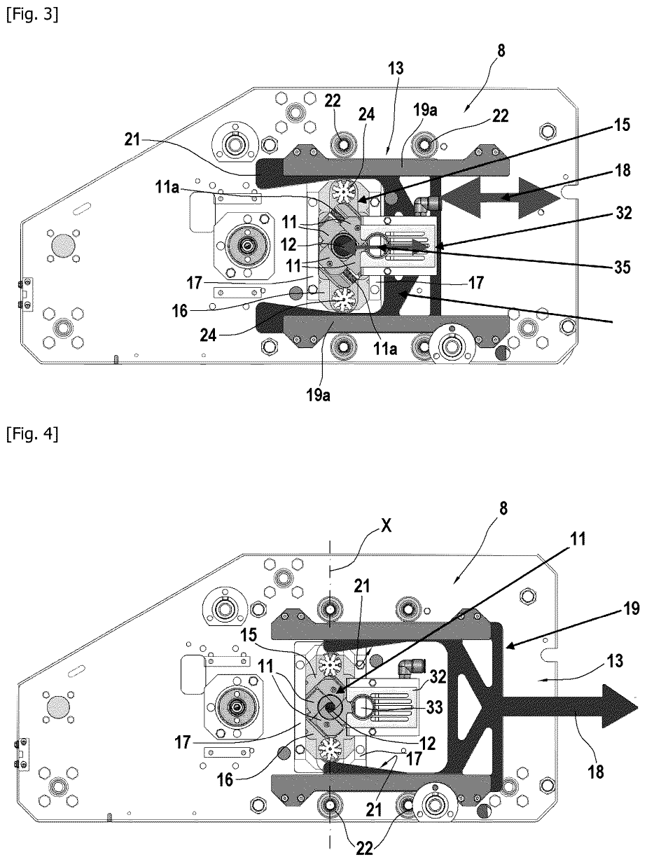

The radial compression device 8 comprises movable jaws 11 which together define a receiving opening 12 for a stopper 3. The radial compression device 8 also comprises a system 13 for displacing the movable jaws 11 by reciprocating movements, in order to modify their arrangement during the movements, between an open configuration, in which the receiving opening 12 can receive a stopper 3 (FIG. 3), and a closed configuration, in which the receiving opening 12 compresses the stopper (FIG. 4). As explained for example in patents EP 1 426 323, EP 1 426 322, EP 1 314 683, the side walls of the receiving opening 12 are delimited by the movable jaws 11 which compress the stopper to a size slightly smaller than the mouth of a neck 2 of the container, so as to enable the insertion device 9 to push the stopper inside said neck. The movable jaws 11 are arranged to slide over one another, being provided with return springs 11a to automatically change from their closed configuration to their open configuration.

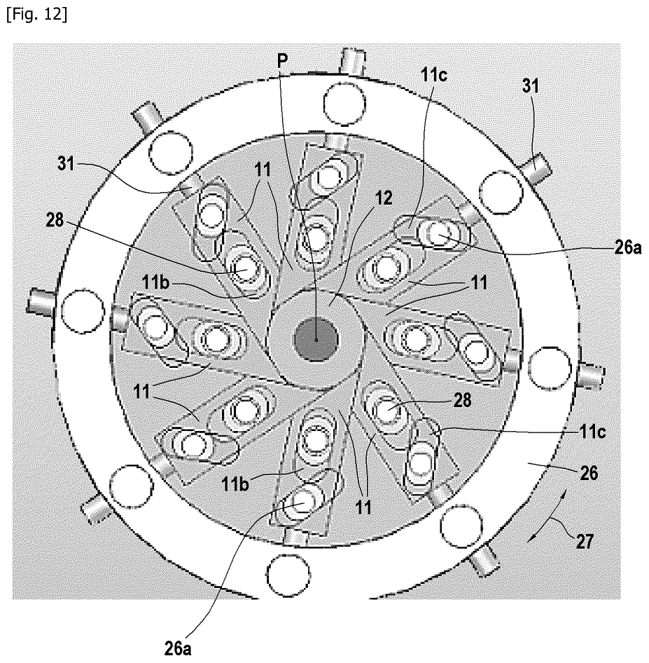

In accordance with a feature of the invention, all the movable jaws 11 are mounted to be movable in directions converging at a point P, and the displacement system 13 ensures concentric displacement of all the movable jaws 11 in order to ensure concentric compression of the stopper 3. It should be understood that all the movable jaws 11 are displaced synchronously or simultaneously in their reciprocating movements. In the embodiment shown in FIGS. 3, 4 and 5A to 5C, the radial compression device 8 has four movable jaws 11, whereas in the example shown in FIG. 12, the radial compression device 8 has eight movable jaws 11. Of course, the radial compression device 8 can have a different number of movable jaws, typically between three and twelve, as will be described in the description below.

In the embodiment illustrated in FIGS. 3, 4 and 5A to 5C, the radial compression device 8 comprises a first slide 15 which can move in translation acting on two mutually perpendicular movable jaws 11, and a second slide 16 which can move in translation acting on two other mutually perpendicular movable jaws 11 and cooperating with the two movable jaws 11 of the first slide 15. As a result, the first slide 15 and the second slide 16 are disposed on either side of the four movable jaws 11. The first slide 15 and the second slide 16 are guided in translation in the same direction, represented by the X axis, while being displaced in opposite senses. For example, the first slide 15 and the second slide 16 are guided in translation by guide rails 17 carried by the table 10 and between which the two slides 15, 16 slide.

Two movable jaws 11 are mechanically and functionally associated with the first slide 15, while two other movable jaws 11 are mechanically and functionally associated with the second slide 16, as explained for example in patent EP 1 426 322. The first slide 15 acts, firstly, directly on a movable jaw 11 in perpendicular contact with another movable jaw 11 on which the second slide 16 acts perpendicularly by means of a return spring 11a and, secondly, by means of a return spring 11a on another movable jaw 11 in perpendicular contact with another movable jaw 11 on which the second slide 16 acts perpendicularly. The side walls of these four movable jaws 11 define the circular receiving opening 12 into which a stopper is to be inserted.

In accordance with the invention, the first slide 15 and the second slide 16 are movable in translation. Moreover, the displacement system 13 of the movable jaws 11 is configured to simultaneously displace the first slide 15 and the second slide 16 in opposite senses. In this way, all the movable jaws 11 are simultaneously displaced concentrically towards point P during compression, i.e. when they move from the open configuration to the closed configuration. Similarly, the displacement system 13 of the movable jaws 11 is configured to simultaneously displace all the movable jaws 11 in order that they move from the closed configuration to the open configuration. The slides 15, 16 are displaced by the displacement system 13 in opposite senses and in senses opposite to the sense used for compression.

In a preferred embodiment, the displacement system 13 comprises a first actuator 18 displacing a control part 19 provided with a cam system 21 acting on the first slide 15 and on the second slide 16. The first slide 15 and the second slide 16 are thus displaced by means of a single control part 19, which is actuated by the first actuator 18 to slide alternately. This first actuator 18 can be embodied in any suitable manner and, advantageously, by a brushless motor that enables the speed, acceleration and distance of displacement to be determined, in order to vary the compression diameter of the movable jaws.

In the illustrated example, the control part 19 is in the form of a two-armed fork 19a slidingly guided in a direction perpendicular to the direction of translation X of the slides 15, 16. The control part 19 is slidingly guided by any guide system, for example rollers 22 mounted on the table 10 in the illustrated example. The arms 19a of the fork support the cam system 21 arranged in the form of ramps in order to act on the free ends of the slides 15, 16 opposite those ends cooperating with the movable jaws 11. The cam system 21 is configured to displace the first slide 15 and the second slide 16 in opposite senses in synchronised fashion. Thus, displacing the control part 19 in one sense causes the slides 15, 16 to move towards each other, simultaneously causing all the movable jaws 11 to be displaced to occupy the closed configuration, whereas displacing the control part 19 in the opposite sense causes the slides 15, 16 to move away from each other, simultaneously causing all the movable jaws 11 to be displaced to occupy the open configuration.

Of course, the cam system 21 is configured to ensure progressive displacement of the slides 15 and 16 along the same course. In this way, the displacement course of the slides 15, 16 can be adjusted as a function of the translation course of the control part 19. In the same way, the cam system 21 can be changed in order to modify the sliding amplitude of the slides 15, 16.

The displacement system 13 described above uses a single actuator 18 to displace the two slides 15, 16 simultaneously and synchronously in opposite senses. Of course, it is possible to implement a displacement system using a plurality of actuators in order to ensure concentric displacement of all the movable jaws 11.

According to one advantageous embodiment, the first slide 15 and/or the second slide 16 are provided with an adjustment system 24 for centring the movable jaws 11. In the illustrated example, the first slide 15 and the second slide 16 are provided with an adjustment system 24. This adjustment system 24 is designed to be inserted between a slide 15, 16 and the cam system 21 for adjusting the position of the movable jaws 11 relative to the slide acting on these movable jaws. This adjustment system 24 may take the form of an eccentric shaft acting on a slide. This eccentric shaft is fitted with a star-shaped wheel to determine the axial position of the eccentric shaft and, consequently, the degree of adjustment according to the position of the wheel.

In the embodiment described above, the radial compression device 8 comprises slides 15, 16 which are displaced by sliding. FIG. 12 illustrates another example in which the radial compression device 8 comprises an annular control part 26 controlled in alternating rotation by a first actuator 27 and acting simultaneously on all the movable jaws 11 in order to modify their arrangement during movements, between the open configuration and the closed configuration. As described above, all the movable jaws 11 of the radial compression device 8 are mounted so as to be movable in directions converging at a point P, cooperating with one another at their free end to define the receiving opening 12. The movable jaws 11 are evenly angularly distributed inside the annular control part 26, which acts on the movable jaws 11. Each movable jaw 11 comprises an oblong slot 11b cooperating with a guide pin 28 to guide the movable jaw 11 in radial sliding. Each movable jaw 11 also has an oblong control slot 11c into which an actuating stud 26a is inserted, fastened with the annular control part 26 by means of a shaft 31. The control slots 11c are oriented in a non-radial direction to transform the annular rotational movement of the control part 26 into radial movements, in order to obtain the movement of the movable jaws similar to the movement of a diaphragm. In the illustrated example, the radial compression device 8 has eight movable jaws 11. Of course, the radial compression device 8 can have a different number of movable jaws 11, for example between three and twelve movable jaws 11.

It is clear from the above description that the displacement system of the movable jaws 11 ensures the simultaneous concentric displacement of all the movable jaws 11, in order to ensure a concentric compression of the stopper 3. FIGS. 5A, 5B and 5C illustrate the benefits of concentric compression compared with the prior art, which traditionally uses eccentric compression. In an embodiment with four movable jaws, the prior art proposes mounting two jaws (forming a jaw assembly) on a movable carriage and two other opposing jaws on a stationary carriage. The movable jaw assembly is displaced towards the stationary jaw assembly via a cam to achieve the final compression of the stopper. The stopper compresses as it is displaced from the movable jaw assembly to the stationary jaw assembly. This movement transcribes a translation generating an eccentric compression with respect to the central axis P of the bottle neck, as is clear from FIGS. 6A to 6C. By contrast, the invention opts for concentric compression, creating a translational movement that makes the two jaws or the two slides 15, 16 movable. The compression then becomes concentric and the two slides move in translation towards each other and towards the central point P of the container neck. All the movable jaws 11 are thus displaced towards the central point P with the same movement (identical sense and speed) but also in the opposite direction from the central point P.

Concentric compression offers several advantages. When compressed, the stopper 3 moves in translation concentrically towards its centre, thus limiting friction. This results in less damage to the stopper and generates less dust that could clog the radial compression device or even end up in the neck of the container. Compression is evenly distributed over the entire stopper. In addition, this compression, which is distributed over the entire stopper, prevents the movable jaws 44 from applying a rotational torque to the stopper, which could cause cracks in the cork cells, thereby affecting the mechanical properties of the stopper. The sealing of the stopper could be affected by this rotational torque.

Furthermore, the compression diameter is adjusted on the two slides 15 and 16, so that the concentricity of the compression is maintained for each desired change in the compression diameters. This is not the case on existing machines where only one adjustment is possible on the set of movable jaws. Hence, in addition to the eccentric compression, the adjustment is also eccentric, which results in poor quality sealing when it is desired to use larger diameter stoppers.

It should be noted that a larger diameter stopper should be less compressed than a smaller diameter stopper. This is to avoid damaging the cork cells that affect the mechanical properties of the stopper, in particular its elasticity when the diameter returns in the neck of the container after compression. This has a significant impact on the sealing and lifespan of the stopper.

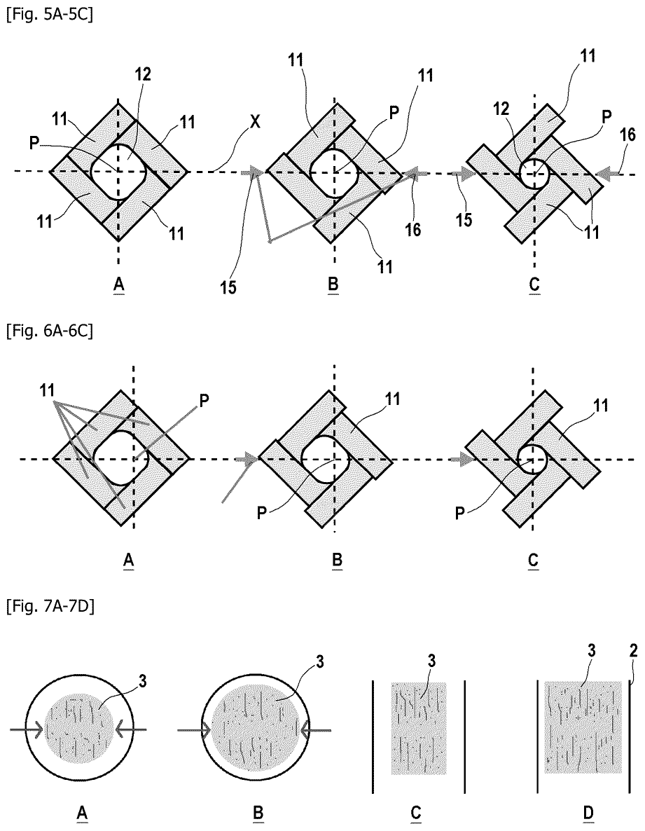

FIGS. 7A and 7B show a stopper 3 still in the compressed position (before its return to elasticity), in the neck of a container with high compression for FIGS. 7A, 7C (small diameter stopper) and with low compression for FIGS. 7B, 7D (large diameter stopper). Insofar as such a stopper has undergone concentric compression in accordance with the invention, the stopper 3 is correctly positioned inside the neck.

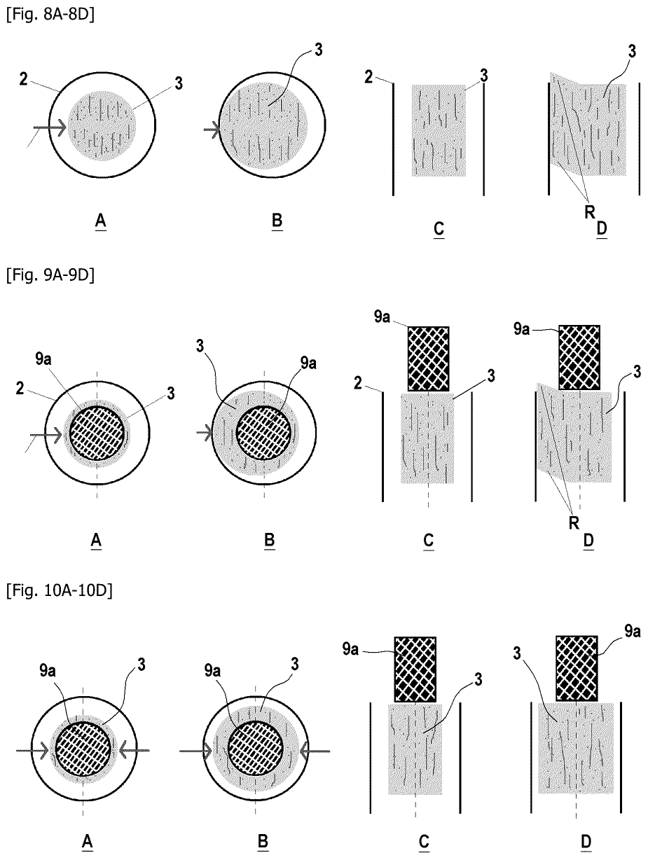

FIGS. 8A and 8C show a stopper 3 still in the compressed position (before its return to elasticity), inserted into the neck of a container, with strong eccentric compression for FIGS. 8A, 8C (small diameter stopper) and with weak compression for FIGS. 8B, 8D (large diameter stopper). Insofar as such a stopper has undergone eccentric compression according to the prior art, the stopper is not correctly positioned inside the neck. There is a curl R in the stopper 3 due to the friction of the stopper along the neck. The stopper 3 is damaged, affecting the sealing and lifespan of the stopper.

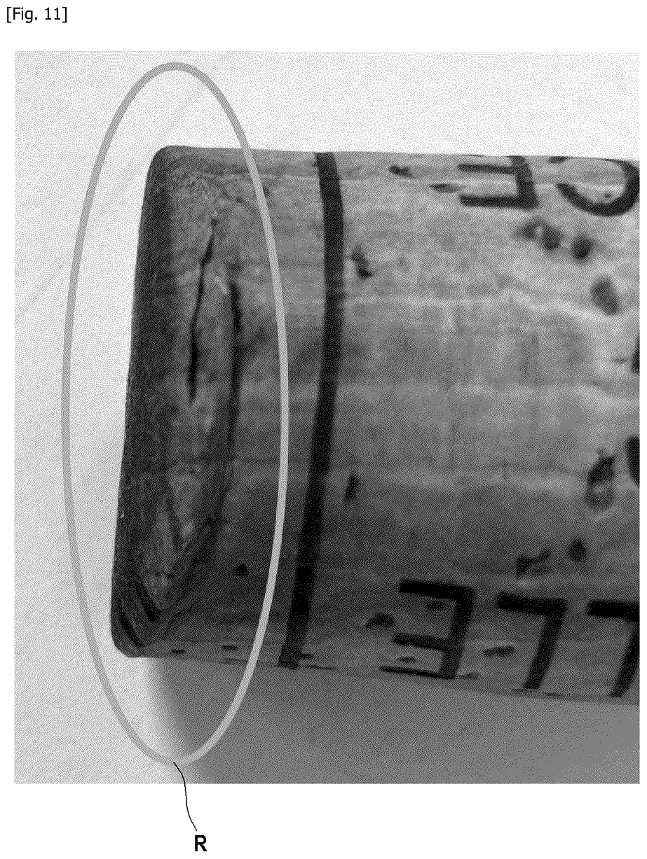

In addition, it should be noted that the eccentric compression of a wider stopper does not allow perfect centring of the entry of the stopper into the neck of the container, as it is eccentrically depressed due to its eccentric compression. FIGS. 9A to 9D illustrate the position of the insertion device 9 with a stopper having eccentric compression according to the prior art. As can be seen from FIGS. 9B and 9D, this has the effect of forming a curl R (inside) in the stopper, due to friction along the neck and due to an eccentric pressing with respect to the centre of the stopper 3. This results in a poor-quality sealing, which reduces the stopper lifespan and increases the risk of dripping (leaking stopper) through the curl. FIG. 11 shows a stopper with such a curl defect R.

In contrast, FIGS. 10A to 10D show the position of the insertion device 9 with a stopper 3 having concentric compression in accordance with the invention, resulting in no defect, whatever the compression and whatever the diameter of the stopper.

The sealing machine 1 in accordance with the invention comprises an insertion device 9 from any type known per se. Typically, the insertion device 9 comprises a push rod 9a driven in a reciprocating movement in such a way that the push rod 9a reaches an insertion position in which the stopper 3 is completely inserted into the neck of the container. Once the stopper has been pushed in, the push rod 9a is released from the receiving opening 12 to allow a new stopper to be inserted between the movable jaws 11.

Typically, the sealing machine 1 also includes a dispenser 32 of stoppers 3 for feeding a stopper into the receiving opening 12. This dispenser 32 is supported by the table 10, for example, and comprises a cavity 33 for receiving a stopper from a feed chute 34. This distributor 32 is movably mounted so that it can slide back and forth by means of an actuator 35 to bring the inserted stopper into the cavity 33 above the opening 12 of the radial compression device 8 and to return the distributor to its position for receiving a new stopper, i.e. to a position in which the cavity 33 is located below the outlet of the feed chute 34.

In accordance with the invention, the insertion device 9 comprises an actuation system 9b of the push rod 9a, the movement of which is independent of the movement of the displacement system 13 of the movable jaws 11.

It should be recalled that the system 13 for displacing the movable jaws 11 comprises a first actuator 18. The actuation system 9b for the push rod 9a comprises at least one second actuator 9c for inserting the compressed stopper inside the neck of the container, the operation of which is independent of the operation of the first actuator 18. This second actuator 9c can be embodied in any suitable manner and, advantageously, by a brushless motor that enables the speed, acceleration and distance of displacement to be determined in order to vary the pressing of the stopper into the neck. The second actuator 9c is driven by a control unit of any type known per se, in order to form the actuating system 9b.

Conventionally, the first actuator 18 is driven by a control unit for displacing all the movable jaws 11 concentrically, in order to ensure concentric compression of the stopper, while the second actuator 9c is driven by the control unit to insert the compressed stopper inside the neck of the container. Of course, the second actuator 9c is driven by the control unit to disengage the push rod 9a from the receiving opening after insertion of the stopper into the neck, while the first actuator 18 is driven by the control unit to displace the movable jaws 11 so as to be arranged in their open configuration in order to be able to receive a new stopper.

The use of a first actuator 18 for compressing the stoppers and a second actuator 9c for pressing in the stoppers enables the speed of compression and the speed of pressing to be dissociated. In general, the first actuator 18 has an adjustable actuating speed making it possible to adjust the speed of displacement of the movable jaws 11 in order to adjust the speed of compression of the stopper, while the second actuator 9c has an adjustable actuating speed making it possible to adjust the speed of the push rod 9a so as to adjust the speed of insertion of the stopper independently of the speed of compression of the stopper.

The object of the invention allows to mechanically dissociate the compression movement and the pressing movement in order that the compression speed and the pressing speed can be adjusted independently, whatever the rate. It is therefore possible to improve sealing quality while also preserving the intrinsic quality of the stopper. Either by improving the regularity of sealing by optimising the speed of compression and the speed of pressing at the machine's maximum rate and maintaining this dynamic regardless of the rate. As a result, the sealing quality is consistent regardless of variations in rate. Or by improving the pure quality of the sealing by reducing the compression speed as much as possible while maintaining the fastest possible pressing in at each rate set. As a result, the sealing is better.

The combination of the two previous improvements on the sealing quality and stopper preservation enables flexibility to be improved for various bottle and stopper formats. Indeed, by using two different drives to control speed, acceleration and angular positioning, it is possible to replace manual adjustment of the compression of the movable jaws with automatic adjustment and to control the movements and positions as well as the pressing in of the stopper.

Automatic compression adjustment enables compression diameters and movement speeds to be predefined and set. The result is an ideal optimisation of the compression between the diameter of the stopper and that of the neck of the container, in addition to automatic optimisation of the kinematics of the compression speed and of the pressing speed according to the rate.

This is all the more advantageous given that today the choice of container neck diameters and stopper diameters is more varied than ever before. The same applies to the types of stoppers, which are increasingly varied in terms of material. There are natural cork stoppers, agglomerates (a mixture of cork granules or dust with a binder) and plastics. Each one has different mechanical properties and requires a suitable sealing. For example, plastic stoppers are less efficient mechanically, particularly when it comes to restoring elasticity, which is low, and must therefore be less compressed. On the other hand, some agglomerated stoppers have a strong return to elasticity and require a higher pressing speed to avoid packing phenomenon. As far as natural stoppers are concerned, there is also diversity between batches, so there is an interest in optimising sealing according to cork density.

In addition to conventional bottles, the sealing machine according to the invention can also be used on the same machine to seal larger containers such as volumes of 300 cL to 600 cL and more). Indeed, the stoppers for such containers have a diameter of 30 to 38 mm instead of 24 to 26 mm, and existing machines are unable to adapt to this amplitude, in particular because of the opening diameter of the jaw assembly block and the compression diameter. With concentric compression and automated compression adjustment, it is now possible to seal these large bottle formats with a suitable machine height. In the same way as with conventional bottles and stoppers, it is therefore possible to optimise the sealing quality of these bottles with a high-performance, long-lasting closure.

The sealing machine according to the invention makes it possible to improve sealing quality in a way that has never been achieved before. This machine is capable of adapting to all developed ranges of bottles and stoppers, by optimising the compression and pressing parameters to obtain a sealing quality that preserves wines better over time.

1. A machine for sealing containers provided with necks, by inserting stoppers inside the necks of the containers, the machine comprising a frame delimiting at least one sealing station each having:
a support surface for a container;
a compression device for radially compressing the stoppers, comprising movable jaws defining a receiving opening for receiving a stopper, and a displacement system for moving the movable jaws in reciprocating movements in order to modify the arrangement thereof during the movements, between an open configuration, in which the receiving opening can receive a stopper, and a closed configuration, in which the receiving opening compresses the stopper:
a insertion device for inserting a stopper inside the neck of a container, comprising a push rod, driven by a reciprocating movement in such a way that the push rod reaches an insertion position in which the stopper is completely inserted inside the neck of the container, characterised in that:
all the movable jaws of the compression device are mounted so as to be movable in directions converging at a point (P);
the displacement system of the movable jaws ensures the concentric displacement of all the movable jaws, in order to ensure concentric compression of the stopper;
the insertion device comprises an actuation system of the push rod, the movement of which is independent of the movement of the displacement system of the movable jaws.

2. The machine according to claim 1, wherein the displacement system of the jaws comprises at least one first actuator driven by a control unit to displace all the movable jaws concentrically in order to ensure concentric compression of the stopper, while the actuation system for actuating the push rod comprises a second actuator driven by the control unit to insert the compressed stopper inside the neck of the container.

3. The machine according to claim 2, wherein the second actuator is driven to disengage the push rod from the receiving opening after insertion of the stopper into the neck, while the first actuator is driven by the control unit to displace the movable jaws so as to be arranged in their open configuration in order to be able to receive a new stopper.

4. The machine according to claim 2, wherein the first actuator has an adjustable actuating speed making it possible to adjust the speed of displacement of the jaws in order to adjust the speed of compression of the stopper, while the second actuator has an adjustable actuating speed making it possible to adjust the speed of the push rod so as to adjust the speed of insertion of the stopper independently of the speed of compression of the stopper.

5. The machine according to claim 1, wherein the compression device comprises a first slide which can move in translation acting on two movable jaws and a second slide which can move in translation acting on two other movable jaws, the first slide and the second slide being guided in translation in the same direction and being displaced in opposite senses.

6. The machine according to claim 5, wherein the first slide and the second slide are displaced by means of a control part provided with a cam system and actuated sliding back and forth by a first actuator.

7. The machine according to claim 5, wherein the first slide and/or the second slide are provided with an adjustment system for centring the movable jaws.

8. The machine according to claim 1, wherein the compression device comprises an annular control part controlled in rotation back and forth by a first actuator and acting simultaneously on all the movable jaws in order to modify their arrangement during movements, between the open configuration and the closed configuration.

9. The machine according to claim 8, wherein the compression device comprises between three and twelve movable jaws and in that the annular control part acts on the movable jaws distributed angularly inside the annular control part.

10. The machine according to claim 3, wherein the first actuator has an adjustable actuating speed making it possible to adjust the speed of displacement of the jaws in order to adjust the speed of compression of the stopper, while the second actuator has an adjustable actuating speed making it possible to adjust the speed of the push rod so as to adjust the speed of insertion of the stopper independently of the speed of compression of the stopper.

11. The machine according to claim 2, wherein the compression device comprises a first slide which can move in translation acting on two movable jaws and a second slide which can move in translation acting on two other movable jaws, the first slide and the second slide being guided in translation in the same direction and being displaced in opposite senses.

12. The machine according to claim 2, wherein the first slide and the second slide are displaced by means of a control part provided with a cam system and actuated sliding back and forth by a first actuator.

13. The machine according to claim 2, wherein the compression device comprises an annular control part controlled in rotation back and forth by a first actuator and acting simultaneously on all the movable jaws in order to modify their arrangement during movements, between the open configuration and the closed configuration.
